(19) United States
(12) Patent Application Publication
(10) Pub. No.: US 2014/0376822 A1
(43) Pub. Date: Dec. 25, 2014

(54) Method for Computing the Similarity of Image Sequences

(71) Applicants: Michael Holroyd, Charlottesville, VA (US); Jason Lawrence, Charlottesville, VA (US); Abhi Shelat, Charlottesville, VA (US)

(72) Inventors: Michael Holroyd, Charlottesville, VA (US); Jason Lawrence, Charlottesville, VA (US); Abhi Shelat, Charlottesville, VA (US)

(21) Appl. No.: 13/926,449

(22) Filed: Jun. 25, 2013

(51) Int. Cl. G06K 9/62

(52) U.S. Cl. CPC G06K 9/6212
USPC 382/219

(57) ABSTRACT

A method for determining the similarity between two or more image sequences, and the application of that method to determining the temporal location of periodic or semi-periodic motion in a sequence of images or video.

### CROSS-REFERENCE TO RELATED APPLICATIONS

This application claims the benefit of U.S. Provisional Application Ser. No. 61/664,325 “Method for Computing the Similarity of Two Image Sequences” filed June, 2012.

### STATEMENT REGARDING FEDERALLY SPONSORED RESEARCH

This invention was made with government support under SBIR IIP-1142829 awarded by the National Science Foundation. The government has certain rights in the invention.

### FIELD OF THE INVENTION

The present invention relates to image and video analysis, and in particular to determining the similarity between squences of images or video and for detecting periodic motion in sequences of images or video.

### BACKGROUND OF THE INVENTION

The present invention consists of a computational method for identifying similar digital image sequences such as those comprising all or part of a video. The current invention can be used, for instance, to identify repeating portions of an image sequence that shows a scene undergoing partial or full periodic motion. This includes automatically identifying the video frame at which a person or object makes one complete 360-degree revolution as they rotate in front of a camera at either a fixed or variable speed of rotation.

A number of prior methods attempt to detect cyclic motion in the case of a non-stationary (moving) observer. This relaxes the assumption that the repetitive motion produce a repeating sequence of images. This includes the method proposed by Allmen and Dyer, Cyclic Motion Detection Using Spatiotemporal Surfaces and Curves (International Conference on Pattern Recognition 1990) as well as the method of Seitz and Dyer, View-Invariant Analysis of Cyclic Motion (International Journal of Computer Vision 1997). Common to both of these methods is that they must track the 2D image locations of 3D features on the moving object. In contrast, our method assumes a stationary observer and thus can rely on the fact that the motion will produce a repeating sequence of images. This simplifying assumption avoids the difficult and error-prone step of isolating and tracking 3D features.

Xu and Aliaga, Efficient Multi-viewpoint Acquisition of 3D Objects Undergoing Repetitive Motions (ACM Symposium on Interactive 3D Graphics 2007) introduced a method for estimating the 3D surface geometry of an object from a pair of image sequences recorded while the scene undergoes “repetitive” motion (their definition of “repetitive” is included in the definition of “semi-periodic motion” used in this document). A cornerstone of their technique is locating loop points in the captured sequences; however, this process relies on compensating for motion of the camera with respect to the scene (i.e., tracking features like the methods described in the preceding paragraph) and it only considers single frame pairwise comparisons. The current invention is an improvement that compares a longer subsequence of frames and increases the reliability of determining the periodic motion in the input.

Schodl et. al. Video Textures (Proc. SIGGRAPH 2000), provide a way of extending a finite video of a repetitive motion (e.g., flickering flame, running water, etc.) to an infinite sequence by replaying the frames out of their original order. The basic idea is to identify pairs of frames that give the appearance of a smooth transition and choose these alternative paths according to some schedule of probabilities. Although these methods consider the pairwise distance between subsequences of video frames, they do not attempt to reduce the computational expense of this operation by focusing only on a subset of image pixels. The current invention is an improvement that improves efficiency and robustness by sub-sampling the original image sequence.

### SUMMARY OF THE INVENTION

The present disclosure provides a novel framework for determining the similarity of two image sequences and the application of this framework to identifying the temporal location or locations of periodic motion in a longer image sequence or video.

A key component of the present invention is establishing a robust and discriminating distance function that assigns a value to dissimilar image sequences based on the likelihood that those two sequences show the same scene. The two input image sequences are assumed to be of the same length, alternatively the sequences can be scaled in time and re-sampled to ensure a 1-to-1 mapping between images in the two sequences.

In broad terms, a degree of similarity between two image sequences can be determined by computing a set of statistics for each image sequence (e.g., the mean pixel intensity in each frame), organizing these statistics into a list called a feature vector for each sequence using a consistent and predetermined process, and comparing the distances between these lists using a standard vector-valued distance function (e.g., Euclidean norm) to determine the measure of similarity.

### BRIEF DESCRIPTION OF THE DRAWINGS

For a more complete understanding of the invention, reference is made to the following description and accompanying drawings, in which:

FIG. 1 is an diagram of a system for computing the similarity between two image sequences;

FIG. 2 is an illustration of the present invention applied to detecting the loop-point in a video; and

FIG. 3 is an illustration of three methods for subsampling the image sequences.

### DETAILED DESCRIPTION OF THE PREFERRED EMBODIMENTS

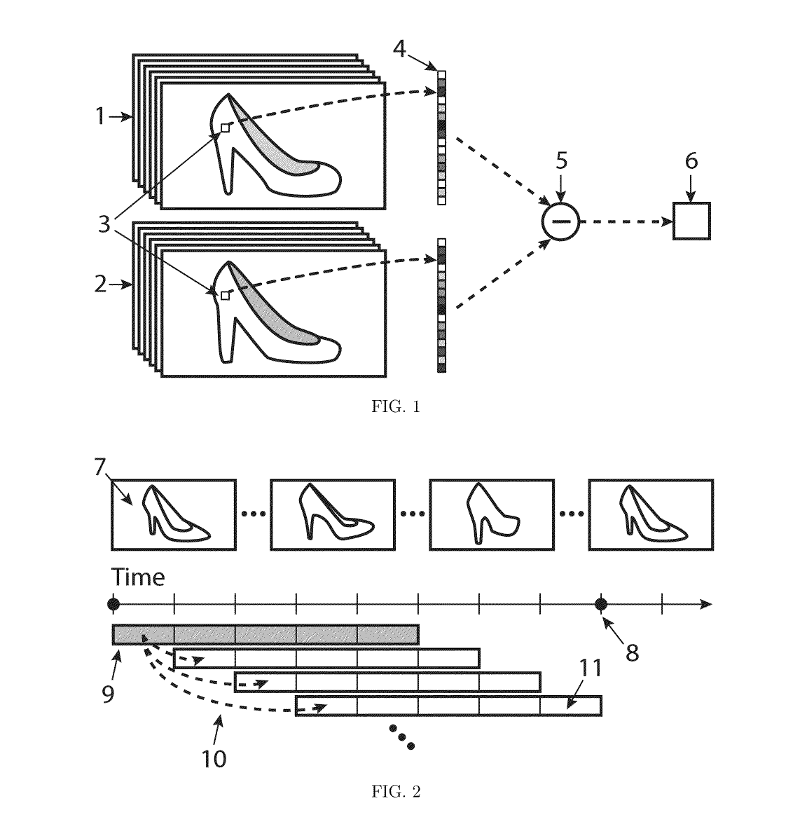

An illustrative embodiment of the disclosed invention shown in FIG. 1 takes as input two sequences of images (such as frames from a video) depicted as a top sequence of images [1] and a bottom sequence of images [2]. The figure shows the same pixel location [3] in both sequences of images is mapped to the same spot in the vector representation [4], which is then used by the system [5] to produce a final decision [6] about the similarity of the two sequences.

The current invention includes methods that use any linear or non-linear combination of the pixel values in the frames composing each sequence to create the representative vectors [4] described above, but here we discuss a particular method for computing the feature vectors, favored for its efficiency and robustness.

Given two or more image sequences, the first step is to compute a representative vector from each sequence as depicted in FIG. 1 [4], which will later be used to computing the difference [5] between each image sequence. Many functions are applicable for mapping the image sequence to this vector, such as the results of spatial filters or convolutions of the full image (e.g., Gaussian, Laplacian, sine, Lancoz, etc.), the application of linear dimensionality reduction algorithms (k-means clustering, Principal Component Analysis, Singular Value Decomposition, or other matrix factorization techniques), as well as non-linear combinations including the application of gamma correction and more general image tone mapping operators and non-linear dimensionality reduction methods such as Isomap or Locally Linear Embedding.

In the preferred embodiment, each image sequence is first denoised using a standard approach such as convolving the color channels with a small Gaussian kernel, and then the resulting pixels are serialized directly into a representative vector. We note that denoising significantly increases robustness by reducing the effect of camera noise and small transient image features irrelevant to the broader image sequence similarity. The distance between these resulting vectors is computed using the normalized cross correlation (NCC) function. In this case, a value close to one would indicate a high degree of positive correlation and one would conclude that the two sequences are similar. On the other hand, if the NCC is closer to zero or negative one, this would indicate that the two image sequences are dissimilar.

A typical 30 second 1,920×1,080 video contains over 1.8 billion individual pixels, and performing computations on this intractable workload directly would result in an inefficient technique. Instead, in the preferred embodiment we compute the representative vector based on only a subset of the pixels in the input image sequences. Selection of the pixel subset is another contribution of the present invention.

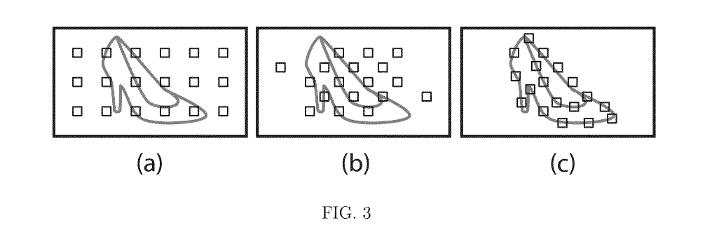

One approach is to use a fixed pattern of pixel locations as shown in FIG. 3(a). Another approach is to use a fixed pattern that under-samples some regions of the raster grid in favor of others, such as those expected to contain a greater amount of information that will aid the process of determining the degree of similarity between the two sequences. The pattern in FIG. 3(b) is an example of one such pattern. In this case, the fixed subset of pixels favors locations near the center of the raster grid. Another approach is to choose a subset of pixels that depends on the set of input image sequences. This includes incorporating standard theoretical measures of information content, such as variance or entropy, in the process used to choose the pixel subset. FIG. 3(c) provides one such example of this approach. In this case, the pixel subset has been constructed by sampling pixel locations according to a probability distribution proportional to the variance at each pixel. In one embodiment, the variance at each pixel used to configure the probability distribution can itself be approximated by inspecting a subset of the images in the sequences.

One use of the present invention also claimed in this application is to extend the prior invention described by U.S. Provisional Patent No. 61/609,313. This embodiment is illustrated in FIG. 2 and enables recovering a type of digital representation of a 3D object from a video recorded at a fixed frame rate while the object rotates around a single axis at either a fixed or variable speed without knowing the precise speed of rotation a priori.

The process involves the following steps:
Select a frame in the video sequence as a reference videoframe [7]. The objective of the system that we describe in this patent is to identify the first frame in the sequence strictly greater than the reference that corresponds to one full rotation of the object (i.e., the first loop point or period). In FIG. 2 the reference frame is the first frame in the video videoframe [7] and the objective is to identify the loop frame loopframe [8].
Choose a comparison template with respect to the reference frame that establishes the image sequence used in the comparison. In FIG. 2 the template initialsubsequence [9] includes the reference frame and the five frames immediately following it. Other examples are longer time template, shorter time template, template offset from the reference, or a template with gaps, etc.
Define the set of possible loop points as a subset of frames in the video. In FIG. 2, this set consists of positions 2, 3, . . . , n −5 where n is the number of frames in the sequence. For each candidate looppoint in this set, use the same template initialsubsequence [9] described in step #2 to form a subset of video frames, but now with respect to the current frame. This produces several image sequences: one sequence corresponding to the reference frame and its template initialsubsequence [9] and one corresponding to the possible loop-points under consideration and their templates framemapping [10]. Use the present invention to compute the similarity of these two image sequences and store the resulting value in an array.
Repeat step #3 for each frame in the set of possible loop points.
Identify the frame in the set of possible loop points with either the smallest or greatest similarity value (the choice of maximum vs. minimum depends on the particular instantiation of the present invention) loopframe [8]. Output the difference between the reference frame and this extrema in units of video frames.

Note that the period computed by the preceding method can be converted into seconds if the frame rate, measured in frames per second, of the video is known.

What is claimed:

1. A method for determining from two or more sequences of images the similarity between those sequences, the method consisting of: using a system of processing units to form a representative vector from the pixels comprising each sequence of images, and using the same system to determine the difference between those representative vectors.

2. The method of claim 1 wherein the method of computing the representative vector considers only a subset of the pixels comprising each sequence of images.

3. The method of claim 2 wherein the subset's sub-sampling positions are determined based on statistics from the image sequence's pixel data.

4. A method for determining the temporal location of periodic or semi-periodic motion in a sequence of images, the method consisting of: using a system of processing units to compute the similarity between two or more image subsequences, those image subsequences coming from the initial sequence of images.

5. The method of claim 4 wherein one image sequence is fixed, and compared with all other image subsequences of the same length present in the original sequence of images.
